(19) United States
(12) Patent Application Publication
(10) Pub. No.: US 2006/0056834 A1
(43) Pub. Date: Mar. 16, 2006

(54) Image-recording apparatus

(75) Inventors: Wataru Sasaki, Asaka (JP); Mutsumi Naruse, Asaka (JP); Yukitaka Takeshita, Asaka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/226,308

(22) Filed: Sep. 15, 2005

(30) Foreign Application Priority Data
Sep. 15, 2004 (JP) 2004-268479
Sep. 24, 2004 (JP) 2004-276420

(51) Int. Cl. G03B 1/66

(52) U.S. Cl. 396/284

(57) ABSTRACT

When a film door is opened, and concurrently when an instant film pack is unloaded from a pack compartment, a spring member causes a counter lever to rotate so that an extremity of the counter lever is disengaged from teeth of a gear, and hence is reset. Furthermore, when the film door is closed, a first slope section of a first rib guides a second slope section of a second rib. Moreover, when an instant film pack is loaded, a third rib is pressed by the instant film pack. In any case, the extremity of the counter lever is engaged with teeth of the gear. Thus, a counter is set ready to perform counting operations in response to a subsequent sequence with which instant film sheets are transferred.

### BACKGROUND OF THE INVENTION

1. Field of the Invention

The present invention relates to an image-recording apparatus including a pack compartment which accommodates a media pack containing stacked recording media to record images thereon, the image-recording apparatus which sequentially records images, one by one, respectively on the recording media accommodated in the pack compartment, and which accordingly sends out the image-recorded media one by one.

2. Description of the Related Art

As an example of the image-recording apparatus, a printer which records images respectively on instant film sheets has been heretofore known. A printer of this type is provided with a pack compartment into which to load an instant film pack in which instant sheet films are contained in stack, a film door which covers the pack compartment openably and closably, and a display section which displays the number of remaining instant film sheets contained in the instant film pack loaded in the pack compartment. An image is recorded on an instant film sheet in the following process. Out of the instant film sheets inside the pack compartment, the first instant film sheet is lifted upwards with a claw, and is transferred with transfer rollers. Beams of light of three colors are irradiated alternately from light-emitting devices respectively having luminescent red (R), green (G) and blue (B) colors onto the instant film sheet thus transferred, and thus a latent image is written thereonto. Subsequently, a developer reservoir which the instant film sheet has is squeezed by spread rollers, and the developer is spread out (as disclosed in Japanese Paten Laid-open Official Gazette No. 2002-94900, for example).

The instant film pack needs to be kept in a state of being blocked from light before it is used. For this purpose, the instant film pack is provided with a light-blocking plate and the like. When the instant film pack is about to be used, the light-blocking plate needs to be discharged or opened.

In this regard, Japanese Patent Laid-open Official Gazette No. 2000-89347 has disclosed a control method of controlling the discharge of light-blocking plate in a camera into which an instant film pack is loaded, and which takes photos onto instant film sheets contained in the instant film pack. According to the control method, the camera is provided with an open and closure detecting switch which detects whether a lid member provided so as to load an instant film pack through is opened or closed. Whether or not an instant film sheet has been loaded is detected by the open and closure detecting switch being changed between on and off. Thus, a light-blocking plate is discharged.

Furthermore, in the case of Japanese Patent Laid-open Official Gazette No. 2001-111924, a camera is provided with a switch which is turned on and off in accordance with the loading and unloading of an instant film pack. Thus, whether or not instant film packs have been changed is detected by the switch being changed between on and off.

In the case of the methods as disclosed in Japanese Patent Laid-open Official Gazettes No. 2000-89347 and No. 2001-111924, it is detected only that the switch is, for example, on at present is in a state However, it can not be known whether the light-blocking plate having been already discharged results from the present-time loading or changing of an instant film pack, or results from the previous loading or changing of an instant film pack. For this reason, change of the switch between on and off needs to be always monitored, and thus a history of the change needs to be remembered. This leads to constant power consumption, and accordingly this hinders power from being saved.

As measures to solve this problem, it may be conceived that a printer is provided with a non-volatile memory in which a history of change of the switch between on and off is stored. Even if the printer is provided with the non-volatile memory, however, a history of change of the switch between on and off can not be recorded while power supply is being turned off. The non-volatile memory is insufficient to solve the problem.

A method using a mechanical counter can be conceived in order to solve the problem. According to the method, the mechanical counter and a sensor are disposed in the printer. By means of counting the number of its change in position or posture, the mechanical counter displays a message that the media pack loaded in the pack compartment is in a state of being unused. In addition to this, the mechanical counter displays a message on how many recording media have been unloaded from the media pack or a message on how many recording media are left unused in the media pack, after the media pack started to be used. The mechanical counter keeps the message displayed even while power supply is off. The mechanical counter again displays the message that the media pack of being unused, when the media pack is unloaded from the pack compartment. Furthermore, the sensor detects whether or not the mechanical counter is displaying the message that the media pack is in the state of being unused. This disposition causes the sensor to detect that the mechanical counter is displaying the message that the media pack is in the state of being unused, when power supply is on. If do so, an operation is carried out in order to discharge, or open, the light-blocking plate. This puts a printer in a state of being capable of printing.

### SUMMARY OF THE INVENTION

With regard to the above-described printer, the mechanical counter does not add a count, in a case where the film door is closed, power supply is turned on, and the operations are checked, while no instant film pack is being loaded in the pack compartment. This is because an instant film pack is not being loaded in the pack compartment. Accordingly, the mechanical counter displays the message that the media pack is unused. In some cases, when the printer is used in a normal manner with an instant film pack loaded thereinto, the sensor detects that the counter displays a message that the media pack is unused, even if power supply is turned on, and an operation is carried out in order to discharge, or open, the light-blocking plate. In such cases, it can be thought that a critical defect has been caused, including an abnormal rotation of the mechanical counter and a trouble with the sensor which transmits abnormal signals. The printer displays a message that an error has occurred. The mechanical counter may not work even while an instant film pack is in a state of being not loaded in the pack compartment. In this case, similarly, the printer displays a message that an error has occurred. However, the displayed error does not represent any actual error. This brings about a problem that the message is confusing.

The present invention has been made in view of the above circumstances, and provides an image-recording apparatus as follows. The image-recording apparatus inhibits increase in costs. In addition to this, the image-recording apparatus does not reset the counter even in a case where the film door is opened, or closed, while a media pack is in a state of being loaded in the pack compartment. Furthermore, the image-recording apparatus prevents the error in display from occurring, even in a case where the image-recording apparatus is operated while a media pack is in a state of being not loaded in the pack compartment.

In the case of the methods as disclosed in Japanese Patent Laid-open Official Gazettes No. 2000-89347 and No. 2001-111924, it is detected only that the switch is, for example, on at present. However, it can not be known whether the light-blocking plate having been already discharged results from the present-time loading or changing of an instant film pack, or results from the previous loading or changing of an instant film pack. For this reason, change of the switch between on and off needs to be always monitored, and thus a history of the change needs to be remembered. This leads to constant power consumption, and accordingly this hinders power from being saved.

As measures to solve this problem, it-may be conceived that a printer is provided with a non-volatile memory in which a history of change of the switch between on and off is stored. Even if the printer is provided with the non-volatile memory, however, a history of change of the switch between on and off can not be recorded while power supply is being turned off. The non-volatile memory is insufficient to solve the problem.

The present invention has been made in view of the above circumstances, and provides an image-recording apparatus which enables power to be saved.

The image-recording apparatus according to the present invention includes a pack compartment which accommodates a media pack containing stacked recording media to record images thereon. The image-recording apparatus sequentially records images, one by one, respectively on the recording media accommodated in the pack compartment, and -accordingly sends out the image-recorded media one by one. The image-recording apparatus includes: a film door which covers the pack compartment openably and closably; and a counter which performs counting operations in response to a sequence with which recording media in the media pack loaded in the pack compartment are transferred. In the image-recording apparatus, the counter is reset when the film door is opened, and concurrently when the media pack is unloaded from the pack compartment. In addition, in the image-recording apparatus, when the film door is closed, or when a media pack is loaded into the pack compartment, the counter is set in a ready condition in which the counting operations can be carried out in response to a subsequent sequence with which the recording media in the media pack loaded in the pack compartment are transferred.

In the case of the image-recording apparatus according to the present invention, the counter which performs counting operations in response to the sequence with which recording media are transferred is designed to be reset when the film door is opened, and concurrently when the media pack is unloaded. In other words, the counter is reset, while the film door is in a state of being opened, and when the media pack is pulled out. For this reason, the counter is designed not to be reset even in a case where the film door is once opened inadvertently, and then is closed as it is after the inadvertence is noticed. As a consequence, this solves the problem which differs the number of actually remaining recording media which are recordable from the number of remaining recording media which is displayed in the counter.

Moreover, in the case of the image-recording apparatus according to the present invention, when the film door is closed, or when a media pack is loaded into the pack compartment, the counter is designed to be set in the ready condition in which the counting operations can be carried out in response to the subsequent transfer sequence. For this reason, in a case where, for example, the film door is closed while the media pack is in a state of being not loaded, the counter is set in the ready condition in which the counting operations can be carried out in response to the subsequent transfer sequence. If power supply is turned on while the counter is in such a condition, the image-recording apparatus can perform a series of sequences and thereafter can operate the counter. Accordingly, the operations and the like can be checked with no erroneous display.

In this respect, it is also a preferable aspect that the counter be installed on a plane opposite to surfaces respectively of recording media in a media pack loaded in the pack compartment.

Instant cameras and printers each with a system using a movable head, which are conventional image-recording apparatuses, have a camera cone and a movable head. This causes the counters to be disposed in the sides which have a restricted space. Accordingly, this brings about a defect which makes displays respectively of the counters too small to be seen. In the case of the image-recording apparatus according to the present invention, the counter is designed to be disposed on the plane opposite to surfaces respectively of recording media. This eases the restriction on an area in which the counter is disposed. The easement makes it possible to make the display larger. Accordingly, this makes it easy to see the display in the counter. Furthermore, as shown in an embodiment described later, if alphanumeric characters on the display board (alphanumeric plate) constituting the counter are made transparent, if LEDs are concurrently disposed in the back of the display board, and if the display board is concurrently back-lighted by use of these LEDs, this makes it possible to see the display in the counter more easily.

Additionally, this image-recording apparatus may be a printer which sends out recording media, one by one, from a media pack loaded in the pack compartment, and which writes images onto the recording media while transferring the recording media, one by one, in a direction in which the recording media are designed to be transferred, thereby recording the images onto the recording media.

In addition, the recording media in the media pack may be formed of photosensitized materials. This image-recording apparatus may be a camera which takes photos on recording media in the media pack loaded in the pack compartment, and which sends out the recording media on which the photos have been taken.

The image-recording apparatus of the present invention inhibits increase in costs. In addition to this, the image-recording apparatus does not reset the counter even in a case where the film door is opened, or closed, while a media pack is in a state of being loaded in the pack compartment. Furthermore, the image-recording apparatus prevents the error in display from occurring, even in a case where the image-recording apparatus is operated while a media pack is in a state of being not loaded in the pack compartment.

The image-recording apparatus according to the present invention includes a pack compartment that accommodates a media pack containing stacked recording media to record images thereon. The image-recording apparatus records images respectively onto recording media by use of the recording media contained in a media pack accommodated in the pack compartment. The image-recording apparatus sends the recording media out of the apparatus. The image-recording apparatus includes a mechanical counter, a sensor and a control section. By means of counting the number of its change in position or posture, the mechanical counter displays a message that the media pack loaded in the pack compartment is in a state of being unused. In addition to this, the mechanical counter displays a message on how many recording media have been unloaded from the media pack or a message on how many recording media are left unused in the media pack, after the media pack started to be used. The mechanical counter keeps the message displayed even while power supply is off. The mechanical counter again displays the message that the media pack is in a state of being unused, when the media pack is unloaded from the pack compartment. The sensor detects whether or not the mechanical counter displays the message that the media pack is in the state of being unused. The control section causes the media pack in the pack compartment and mechanical counter to transit into a ready-to-use condition on the basis of detection by the sensor that the mechanical counter displays that the media pack is in the state of being unused.

In the present invention, the image-recording apparatus is provided with the mechanical counter and the sensor. For this reason, the image-recording apparatus does not have to be always monitored by use of the sensor. Only on the basis of detection which is performed when power supply is turned on, it can be known whether or not the media pack loaded in the pack compartment is in a state of being unused. This enables power to be saved.

In the image-recording apparatus according to the present invention, it is advantageous that the control section be designed to turn off power supply on the basis of the detection by the sensor that the mechanical counter displays the message that the media pack is in the state of being unused while the power supply is on, which detection comes later in time than the power supply having been turned on.

If the sensor detects that the mechanical counter displays the message that the media pack is in the state of being unused while the power supply is on, which detection comes later in time than the power supply having been turned on, this means that the media pack has been unloaded from the pack compartment. In this case, the power supply to the image-recording apparatus may be turned off. If the power supply is automatically turned off with this timing, this enables more power to be saved.

In this respect, the mechanical counter may be a ratchet counter.

Adoption of a ratchet mechanism makes it possible to construct a mechanical counter, which carries out the operations, by a simple mechanism.

In addition, it is advantageous that the mechanical counter be disposed on a plane opposite to surfaces respectively of recording media in a media pack loaded in the pack compartment.

Conventional instant cameras have a camera cone. This causes the counters to be disposed in the sides which have a restricted space. Accordingly, this brings about a defect which makes displays respectively of the counters too small to be seen. In the image-recording apparatus according to the present invention, the counter is designed to be disposed on the plane opposite to surfaces respectively of recording media. This eases the restriction on an area in which the counter is disposed. The easement makes it possible to make the display larger. Accordingly, this makes it easy to see the display in the counter. Furthermore, as shown in an embodiment described later, if alphanumeric characters on the display board (alphanumeric plate) constituting the counter are made transparent, if LEDs are concurrently disposed in the back of the display board, and if the display board is concurrently back-lighted by use of these LEDs, this makes it possible to see the display in the counter more easily.

Additionally, this image-recording apparatus may be that which sends out recording media, one by one, from a media pack loaded in the pack compartment, and which writes images onto the recording media while transferring the recording media, one by one, in a direction in which the recording media are designed to be transferred, thereby recording the images onto the recording media. In this case, furthermore, the recording media in the media pack may be photosensitized materials. Thus, this image-recording apparatus may write latent images respectively on the recording media by means of exposing the recording media, and may record the images respectively on the recording media by means of developing the recording media while the image-recording apparatus is in the process of transferring the recording media.

In the case of the present invention, as described above, conditions can be duly detected even after power supply is once turned off, and then is turned on. This makes it possible to keep power supply turned off, thus enabling power to be saved.

### BRIEF DESCRIPTION OF THE DRAWINGS

FIG. 1 is a perspective view of a printer as an embodiment of an image-recording apparatus according to the present invention at a time when the printer is viewed from the diagonal front.

FIG. 2 is a view showing how the printer shown in FIG. 1 discharges an instant film sheet on which an image is recorded on the basis of image data from a cellular phone with a camera.

FIG. 3 is a perspective view of the bottom side of the printer shown in FIG. 1 at a time when the bottom side is viewed obliquely from above.

FIG. 4 is a perspective view of the printer shown in FIG. 3 during a time when the film door is in a state of being opened.

FIG. 5 is a perspective view of the printer shown in FIG. 4 during a time when an enclosure is in a state of being removed from the printer.

FIG. 6 is a block diagram showing a control system inside the printer.

FIG. 7 is a perspective view showing an exposed surface of the instant film sheet.

FIG. 8 is a perspective view showing an observed surface of the instant film sheet.

FIG. 9 is a cross-sectional view of a media transfer-spread section.

FIG. 10 is a perspective view of the printer according to this embodiment during a time when the enclosure is in a state of being removed from the printer at a time when the printer is viewed from above the top side.

FIG. 11 is a perspective view of the printer shown in FIG. 10 during a time when an alphanumeric plate is in a state of being attached to the printer.

FIG. 12 is a cross-sectional view of the printer shown in FIG. 10 during a time when the film door is in a state of being closed.

FIG. 13 is a plan view of the printer shown in FIG. 10 during a time when a cover member is in a state of being removed from the printer.

FIG. 14 is a flowchart showing a sequence with which a power supply switch of this printer is turned on and off.

FIG. 15 is a flowchart showing a sequence with which a light-blocking plate is opened, and the opening of the light-blocking plate is shown as a step in FIG. 14.

### DETAILED DESCRIPTION OF THE INVENTION

Hereinafter, descriptions will be provided for an embodiment of the present invention.

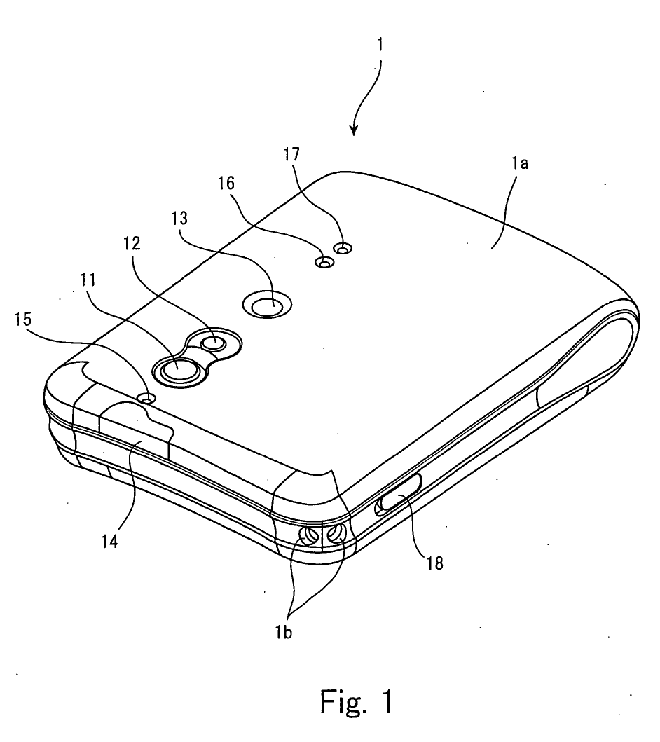

FIG. 1 is a perspective view of a printer as an embodiment of an image-recording apparatus according to the present invention at a time when the printer is viewed from the diagonal front.

This printer 1 is used in combination with a cellular phone or the like. An instant film pack in which instant film sheets are contained in stack is loaded in a pack compartment of the printer 1 (in this case, the descriptions will be provided with an assumption that 10 instant film sheets are contained in the instant film pack). On each of the instant film sheets, a latent image is formed by exposure, a developer is thereafter spread, and thereby the latent image is made apparent. While causing the instant film sheets to be exposed in accordance with image data and sent out, the printer 1 spreads a developer onto the instant film sheets. These instant film sheets are an example of the “recording media” according to the present invention.

Among cellular phones, some can communicate via infrared in compliance with standards of the Infrared Data Association (IrDA standards). Such cellular phones can transmit their own information to other information apparatuses by infrared communication. If those cellular phones are equipped with a camera, the cellular phones can transmit image data to this printer 1. When image data representing an image taken by the cellular phone with a camera or image data received by the cellular phone via email and the like are transmitted to the printer 1 by infrared communication, the printer 1 records the image on an instant film sheet on the basis of the image data. In addition, the printer 1 can re-record the image based on the image data thus transmitted on another instant film sheet by means of simply operating a repeat switch, which will be described, without taking the trouble to transmit the image data from the cellular phone one more time.

This printer 1 is a portable printer that has a thin, light-weighted and small-sized structure as shown in FIG. 1. Two 3V primary batteries are contained in the printer 1. An instant film pack is loaded into an enclosure 1a of the printer 1. An image is recorded on each of the 10 instant film sheets contained in stack in the instant film pack.

A power supply switch 11 (hereinafter referred to as a “power supply SW”) and the repeat switch 12 (hereinafter referred to as a “repeat SW”) are provided on the top side of the enclosure 1a of the printer 1. The power supply SW 11 functions as an operation button, and is used to instruct the printer 1 to turn on and off the power. The repeat switch 12 is used to re-record an image on the basis of received image data. In addition, a counter 13 which indicates how many instant films sheets are left unused is provided on the top side of the enclosure 1a. This counter 13 is a mechanical counter, and displays a numerical value “10” to indicate that 10 instant film sheets are left unused when an unused instant film pack is loaded into the printer 1, and concurrently when power supply is turned on. The counter 13 will, however, be described later in detail. The counter 13 subsequently displays a numeral value representing how many instant film sheets are left unused, which numerical value is obtained by subtracting the number of used instant film sheets, each time an image is recorded onto each of the instant film sheets. When an image is recorded onto a tenth instant film sheet, the counter displays a numerical value “0” to indicate that none of the instant film sheets are left unused.

A transmitting-receiving section 14 is provided to an extremity of this printer 1. This transmitting-receiving section 14 receives incoming image data transmitted by infrared communication, and concurrently transmits signals with which its counterpart is informed of the reception of the image date.

The enclosure 1a of the printer 1 is provided with an LED 15 which indicates power supply condition, an LED 16 which indicates a communication error, and an LED 17 which indicates low-battery condition. The LED 15 which indicates power supply condition is lit when power supply is turned on, and flashes on and off while the printer 1 communicates via infrared. The LED 16 which indicates a communication error is lit when an error occurs in infrared communication. The LED 17 which indicates low-battery condition is lit in order to remind the user that batteries need to be changed, when the batteries contained in the printer 1 decrease in voltage.

A film-door opening switch 18 is provided to a side panel of the printer 1. The film-door opening switch 18 is used to open a film door provided to the bottom side of the printer 1, which film door will be described later. A strap attachment section 1b is provided to a corner section.

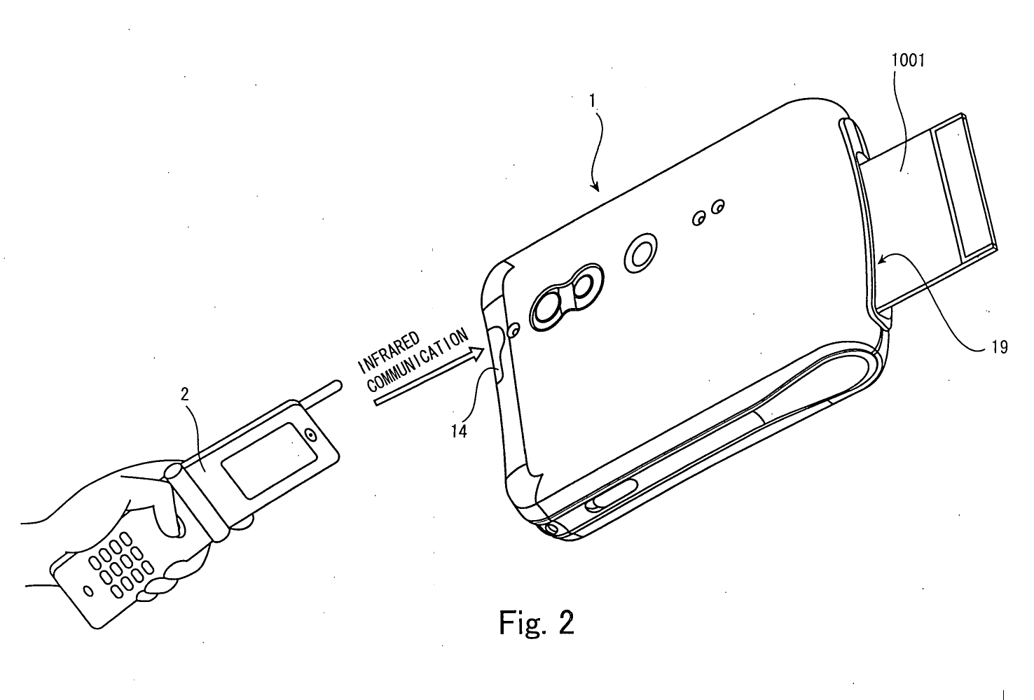

FIG. 2 is a view showing how the printer shown in FIG. 1 discharges an instant film sheet on which an image is recorded on the basis of image data sent from a cellular phone with a camera.

When the cellular phone 2 with a camera is operated while an infrared communication section of the cellular phone 2 with a camera is in a state of being directed to the transmitting-receiving section 14 of the printer 1, image date representing an image taken by the cellular phone 2 with a camera is transmitted to this printer 1 by infrared communication. The printer 1 receives incoming image data transmitted by infrared communication. Thereafter, the printer 1 records onto an instant film sheet 1001 a latent image based on the image data thus received by means of exposure, and thus makes the latent image apparent on the instant film sheet 1001. While doing so, the printer 1 gradually discharges the instant film sheet 1001 from a delivery outlet 19. When the repeat switch 12 is operated later, the printer 1 re-records on another instant film sheet the same image as the printer 1 has previously recorded on the discharged instant film sheet.

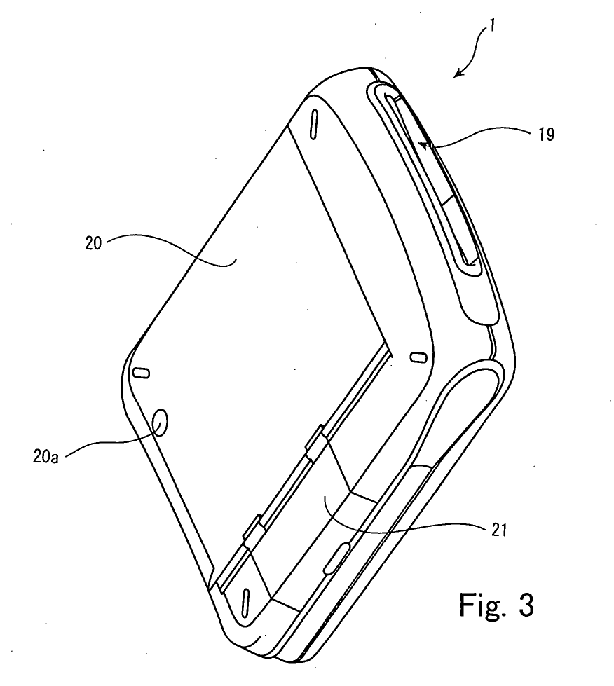

FIG. 3 is a perspective view of the bottom side of the printer shown in FIG. 1 at a time when the bottom side is viewed obliquely from above.

A film door 20 is provided to the bottom side of the printer 1. The film door 20 is opened by means of operating the film-door opening switch 18 shown in FIG. 1. This film door 20 is opened to load an instant film pack into a pack compartment. A pack presence/absence checking window 20a is provided to the film door 20. The pack presence/absence checking window 20a is used to check whether or not an instant film pack is being loaded in the pack compartment. In addition, a battery lid 21 is provided in a way that the battery lid 21 is adjacent to the film door 20. The battery lid 21 is opened to load batteries that supply power to the printer 1.

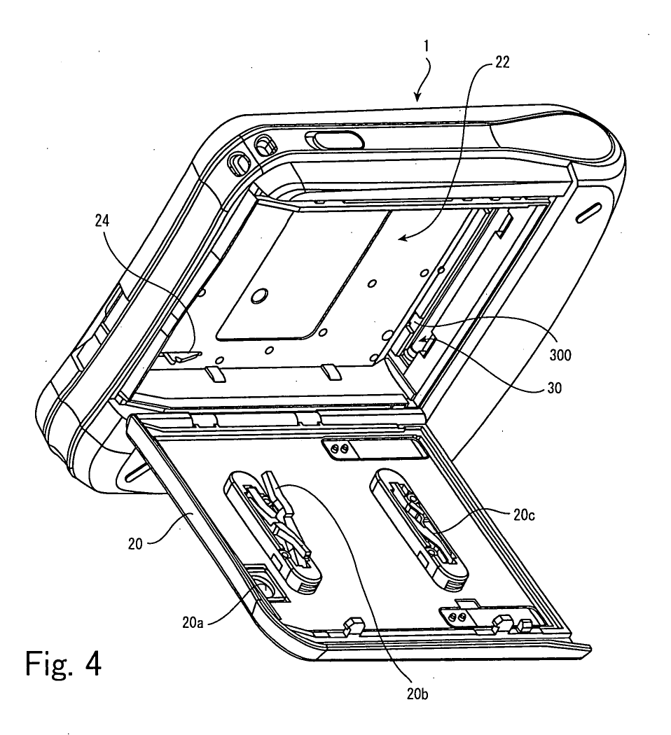

FIG. 4 is a perspective view of the printer shown in FIG. 3 during a time when the film door is in a state of being opened.

The pack presence/absence checking window 20a as well as spring members 20b and 20c are provided to the inside of the film door 20. These spring members 20b and 20c press instant film sheets contained in stack in the instant film pack towards the top side of the printer 1.

In addition, the printer 1 is provided with the pack compartment 22 into which an instant film pack is loaded. An image writing section 300 and a media transfer-spread section 30 are provided to the respective parts outside the pack compartment 22, which parts are on the right side of FIG. 4. The image writing section 300 writes images onto instant film sheets, which are being transferred through the image writing section 300. The image writing section 300 and the media transfer-spread section 30 will be described in detail later. A claw 24 is provided to a part inside the pack compartment 22, which part is on the lower side of FIG. 4. The claw sends out the instant film sheets to the image writing section 300 and the media transfer-spread section 30. Such a configuration causes the claw 24 to lift up an instant film sheet which is the closest to the top side of the printer 1 out of the instant film sheets in the instant film pack, and causes the image writing section 300 to write an image onto the lifted-up instant film sheet while the instant film sheet is being transferred by the media transfer-spread section 30. Thus, the instant film sheet is developed.

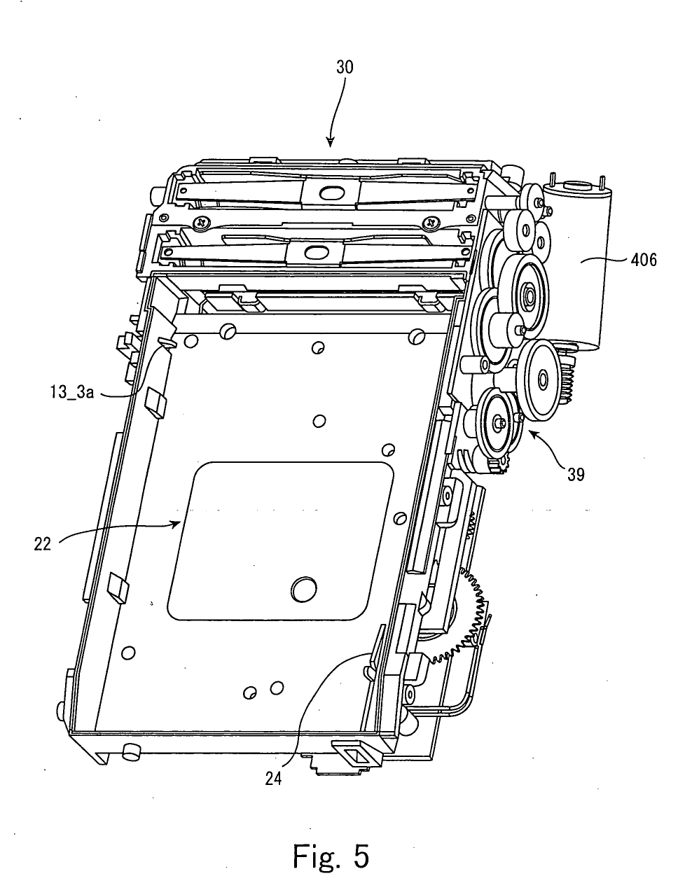

FIG. 5 is a perspective view of the printer shown in FIG. 4 during a time when the enclosure is in a state of being removed from the printer.

FIG. 5 shows a dynamotor 406 and the media transfer-spread section 30 that is provided with a gear row 39. The rear row 39 transmits rotational drive power from the dynamotor 406 to transfer rollers and spread rollers, which will be described later. In addition, FIG. 5 shows the claw 24 which is provided to the inside of the pack compartment 22 and a rib 13_3a of a counter lever which is pressed by means of loading an instant film pack into the pack compartment, which counter lever will be described later.

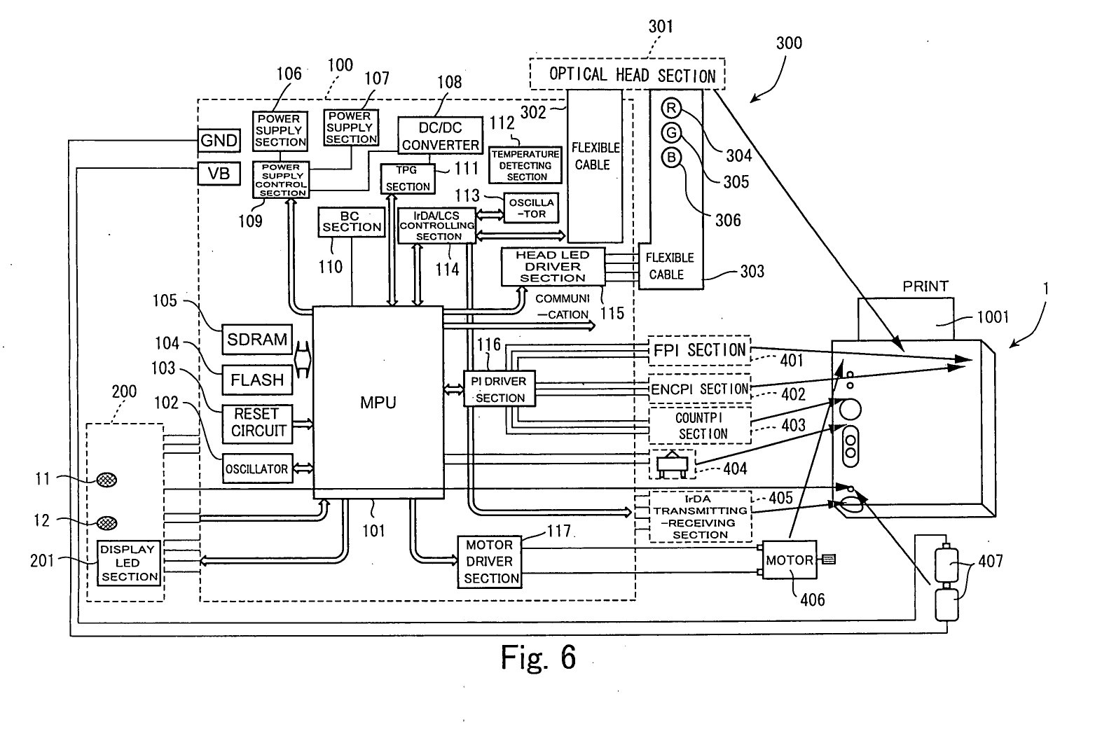

FIG. 6 is a block diagram showing a control system inside the printer.

A schematic view of the printer 1 illustrated in FIG. 1 is shown on the right end of FIG. 6. The entire part of FIG. 6, except for this right end, shows a configuration illustrating the control system of this printer 1. Arrows shown in FIG. 6 indicate dispositional relationships among components constituting the control system in this printer 1.

This printer 1 includes a main substrate section 100, a sub-substrate section 200, the image writing section 300, an FPI section 401, an ENCPI section 402, a COUNTPI section 403, a cam-operated switch 404, an IrDA transmitting-receiving section 405 provided to the transmitting-receiving section 14, and the dynamotor 406.

The sub-substrate section 200 includes the power supply SW 11, the repeat SW 12 and a display LED section 201. The display LED section 201 includes the LED 15 which indicates power supply condition, the LED 16 which indicates a communication error, the LED 17 which indicates low-battery condition, and an LED (not illustrated) which back-lights the counter provided to the back side of the counter 13.

The image writing section 300 includes: an optical head section 301 having a light guide, a liquid crystal shutter (LCS) and the like; flexible cables 302 and 303 which connect the optical head section 301 and the main substrate section 100; and light-emitting devices (LEDs) 304, 305 and 306 which are installed into the flexible cable 303, and which respectively have luminescent red (R), green (G) and blue (B) colors. This image writing section 300 writes a latent image onto an instant film sheet, which is in the process of being transferred, by means of alternately irradiating beams of light of the three colors, R, G and B respectively from the LEDs 304, 305 and 306 to the instant film sheet on the basis of image data received by the transmitting-receiving section 14 in synchronism with pulses for writing instructions. In addition, the two 3V primary batteries 407 are contained in the printer 1.

Hereinafter, descriptions will be provided for the main substrate section 100. Power supply voltage VB of 6V is applied to the main substrate 100 from the primary butteries 407 connected in series. This main substrate section 100 includes a micro processor unit (MPU) 101, an oscillator 102, a reset circuit 103, a flash memory (FLASH) 104 and an SDRAM 105.

The MPU 101 controls the operations of this printer 1 in a coordinated manner.

The oscillator 102 generates resonance signals with predetermined frequencies, and supplies the resonance signals, as clock signals, to the MPU 101 so as to operate the MPU 101.

The reset circuit 103 outputs reset signals which are used to initialize the MPU 101.

The flash memory 104 is a non-volatile memory, and stores an adjustment value and the like to be used to adjust an individual difference intrinsic to the printer 1, which individual difference is determined depending on the mechanism and the like of the printer 1.

The SDRAM 105 is a volatile memory, and stores image data and the like from the cellular phone 2 with a camera.

Furthermore, the main substrate section 100 includes: a power supply section 106 which receives the power supply voltage VB of 6V, and which outputs voltage of 2.5V; a power supply section 107 which outputs voltage of 3.3V; and a DC/DC converter 108 which outputs voltage of 15V. In addition, the main substrate section 100 includes a power supply control section 109 which controls the power supply sections 106 and 107 as well as the DC/DC converter 108 by means of receiving instructions from the MPU 101. In this respect, the voltage of 2.5V is supplied to the MPU 101, and the voltage of 3.3V is supplied to peripheral circuits other than the MPU 101. Moreover, the voltage of 15V is used to drive an LCD, which will be described later.

The printer 1 includes the MPU 101 having a stand-by mode which is a low power consumption mode in order to extend lifetime of the primary batteries 407. Even in a case where the power supply SW 12 is pressed, the MPU 101 is designed to be turned into the stand-by mode when the initialization process is completed. If the printer 1 communicates using infrared communication with the outside while the MPU 101 is in the stand-by mode, the MPU 101 is turned from the stand-by mode to a normal operation mode. Thus, the printer 1 records an image onto an instant film sheet. Thereafter, the MPU 101 is turned from the normal operation mode to the stand-by mode. Additionally, in a case where the repeat SW 12 is pressed, the MPU 101 is turned to the stand-by mode after an image is recorded on an instant film sheet. Furthermore, the MPU 101 causes the power supply control section 109 to control the power supply sections 106 and 107 as well as the DC/DC converter 108 in order that electric power is supplied to the other sections only when the sections needs to operate. If do so, the printer 1 can be used for a long time by use of the primary batteries 407 contained in the printer 1.

As well, the main substrate section 100 includes a BC section 110, a TPG section 111, a temperature detecting section 112, an oscillator 113, an IrDA/LCS controlling section 114, and a head LED driver section 115.

The BC section 110 checks whether or not the power supply voltage VB of the primary batteries 407 has gone under a predetermined value. The MPU 101 makes reference to result of this check. In a case where the BC section 110 determines that the power supply voltage VB of the primary batteries 407 has gone under a predetermined value, the MPU 101 lights the LED 17 which indicates low-battery condition in order to remind the user that that the batteries need to be changed.

The TPG section 111 turns on and off voltage of 15V which is outputted from the DC/DC converter 108.

The temperature detecting section 112 detects the temperature of the image writing section 300. The MPU -101 controls the shutter speeds and the like of the respective shutter sections of the liquid crystal shutter in the optical head section 301 in response to detection signals from the temperature detecting section 112.

The oscillator 113 generates resonance signals with predetermined frequencies, and supplies the resonance signals to the IrDA/ LCS controlling section 114.

The IrDA/LCS controlling section 114 controls the IrDA transmitting-receiving section 405 and the optical head section 301 on the basis of resonance signals from the oscillator 113. The IrDA transmitting-receiving section 405 includes a flashing element and a light-receiving element which are used to communicate via infrared. The IrDA/LCS controlling section 114 transmits to the MPU 101 data which has been photoelectrically converted by the light-receiving element, and transmits to the outside via the flashing element data which causes the MPU 101 to inform external apparatuses that the photoelectrically converted data are transmitted. Furthermore, the IrDA/LCS controlling section 114 controls the liquid crystal shutter provided to the optical head section 301 through the flexible cable 302 on the basis of an instruction from the MPU 101.

The head LED driver section 115 causes electricity based on an instruction from the MPU 101 to flow to the LEDs 304, 305 and 306 through the flexible cable 303, and thereby drives the LEDs 304, 305 and 306.

The printer 1 according to this embodiment is a printer which records a color image onto an instant film sheet in the below-described manner at the same time as the printer transfers the instant film sheet in the sub-scanning direction (direction in which the instant film sheet is transferred) by use of the dynamotor 406. The printer 1 writes R-colored, G-colored and B-colored parts of the image alternately onto the instant film sheet in the sub-scanning direction. With regard to all of the pixels arrayed in a line side by side in the main scanning direction orthogonally intersecting with the sub-scanning direction, the printer 1 writes the same color concurrently.

When a color image is about to be recorded on an instant film sheet, control signals in response to the image data are supplied, through the flexible cable 302, from the IrDA/LCS controlling section 114 to the optical head section 301 constituting the image writing section 300. The control signals are used to control the shutter speeds respectively of the shutter sections of the liquid crystal shutter in the optical head section 301. The shutter speeds respectively of the shutter sections are controlled in response to the image data. Thus, beams of light corresponding to the R, G and B colors are irradiated onto the instant film sheet from the LEDs 304, 305 and 306 which are provided to the flexible cable 303. Hence, a latent image, the representation of which is made up of many light spots (dots), is recorded on the instant film sheet in the width direction. The main scanning direction is this “width direction,” or a direction in which the shutter sections are arrayed one-dimensionally. As a consequence, when the shutter sections are electrically scanned in the main scanning direction, a line of light spots is recorded on the instant film sheet (all the pixels in the line are recorded on the instant film sheet). The electronic scanning by this optical head section 301 records light spots made up of a large number of dots, on the instant film sheet in the main scanning direction. Moreover, in the case of this embodiment, the dynamotor 406 transfers instant film sheets in the sub-scanning direction, as described above. As a consequence, light spots are sequentially recorded, for each group of the large number of dots, by the image writing section 300 in the sub-scanning direction.

As well, the main substrate section 100 includes a PI driver section 116. The PI driver section 116 drives the FPI section 401, the ENCPI section 402 and the COUNTPI section 403. Here, descriptions will be provided for the FPI section 401, the ENCPI section 402 and the COUNTPI section 403.

The FPI section 401 is a photo interrupter that detects whether instant film sheets are present or absent therein.

The ENCPI section 402 is a photo interrupter which outputs encoded signals made of a pulse train, which are synchronized to rotations of the dynamotor 406.

The COUNTPI section 403 is a photo interrupter that detects an initial position of the counter 13.

Furthermore, the cam-operated switch 404 is connected to the main substrate section 100. This cam-operated switch 404 is a switch which monitors an initial position of the transfer mechanism of the printer 1.

In addition, the main substrate section 100 includes a motor driver section 117. This motor driver section 117 receives an instruction from the MPU 101, and thereby controls the rotational speed of the dynamotor 406 in order to make time intervals of the pulse train of the encoded signals outputted from the ENCPI section 402 agree with predetermined time intervals.

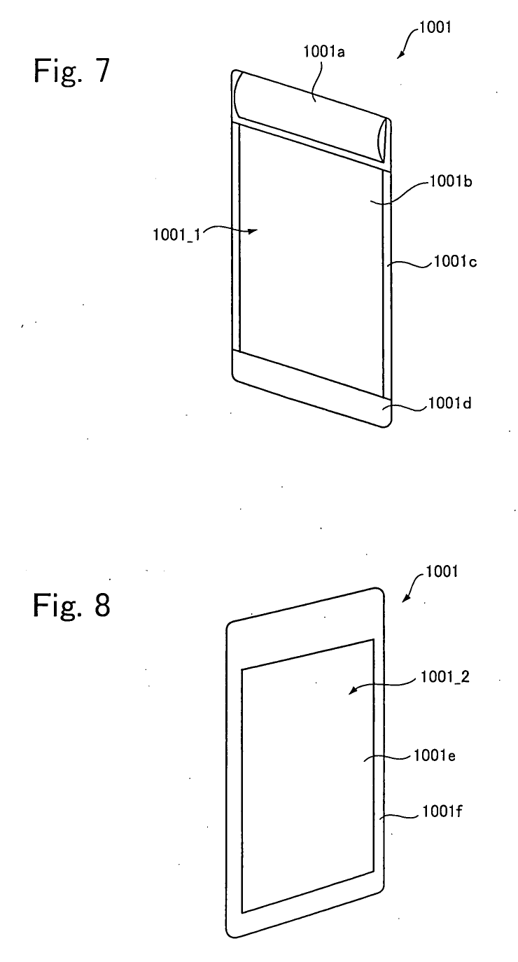

FIG. 7 is a perspective view showing an exposed surface of the instant film sheet. FIG. 8 is a perspective view showing an observed surface of the instant film sheet.

FIG. 7 shows the exposed surface 1001_1 of the instant film sheet 1001. This exposed surface 1001_1 is provided with a developer reservoir 1001a, an exposed section 1001b, marginal sections 1001c and a trap section 1001d. The developer reservoir 1001a is arranged in an extremity of the instant film sheet 1001 in the direction in which the instant film sheet 1001 is transferred. An image is exposed in the exposed section 1001b. The trap section 1001d absorbs a redundant amount of the developer. Furthermore, FIG. 8 shows the observed surface 1001_2 of the instant film sheet. This observed surface 1001_2 includes an observation section 1001e and marginal sections 1001f. By use of the observation section 1001e, an image that has been made apparent is observed, after the latent image is formed by exposure and the developer is spread.

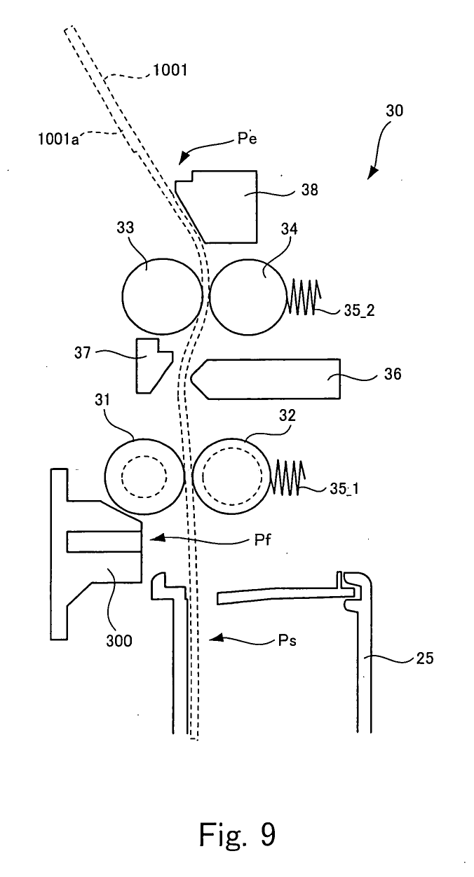

FIG. 9 is a cross-sectional view of a media transfer-spread section.

The media transfer-spread section 30 includes a pair of transfer rollers 31 and 32, which transfer the instant film sheet 1001 while holding the instant film sheet 1001 therebetween. A spring member 35_1 energizes the transfer roller 32 towards the transfer roller 31.

In addition, the media transfer-spread section 30 includes a pair of spread rollers 33 and 34. The spread rollers 33 and 34 are arranged downstream of the pair of transfer roller 31 and 32 in the direction in which the instant film sheet 1001 is transferred. The spread rollers 33 and 34 squeeze out the developer reservoir 1001a with the instant film sheet 1001 held in full width therebetween, and thereby spread the developer. The spring member 35_2 energizes the spread roller 34 towards the spread roller 33.

Furthermore, the media transfer-spread section 30 includes a control plate 36, a film guide 37 and a film guide frame 38. The control plate 36 is positioned between a group of the transfer rollers 31 and 32 as well as a group of the spread roller 33 and 34, and controls the developer which is in the process of being spread. The film guide 37 guides the instant film sheet 1001 to the spread rollers 33 and 34. The film guide frame 38 guides the instant film sheet 1001 to the outside. Moreover, the image writing section 300 is provided in the vicinity of the outlet of the instant film pack 25.

The printer 1 according to this embodiment causes the claw 24 (see FIGS. 4 and 5) to lift up, from a predetermined transfer starting position Ps, an instant film sheet 1001 which is the closest to the top side of the printer 1 out of the instant film sheets 1001 in the instant film pack 25. Thereafter, the printer 1 causes the image writing section 300 to begin to write an image onto the lifted-up instant film sheet at a fixed writing position Pf while the instant film sheet is being transferred by the transfer rollers 31 and 32. Moreover, this printer 1 causes the transfer rollers 31 and 32 to transfer the instant film sheet 1001 while writing the image on the instant film sheet 1001. Subsequently, the printer 1 causes the spread rollers 33 and 34 to squeeze out the developer reservoir 1001a, and thus spreading the developer over the instant film sheet 1001. Then, the printer 1 causes the control plate 36 and the film guide 37 to control the developer which is in the process of being spread, and thus developing the instant film sheet 1001. Afterwards, the printer 1 causes the instant film sheet to be transferred to a predetermined transfer ending position Pe. In this manner, the printer 1 records the image onto each one of the instant film sheets 1001.

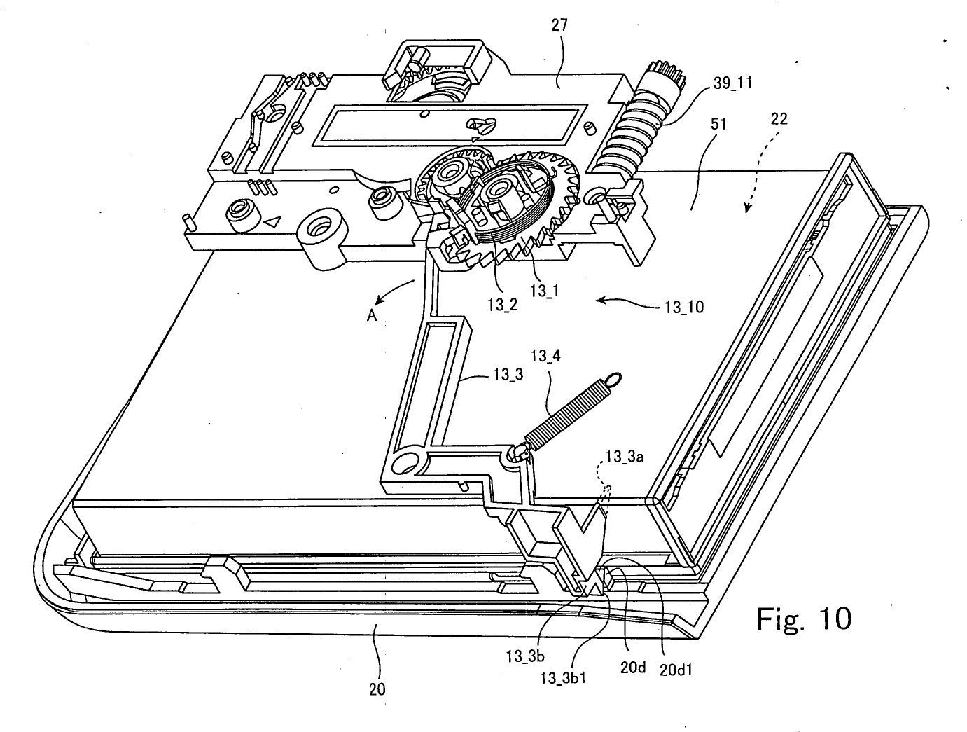

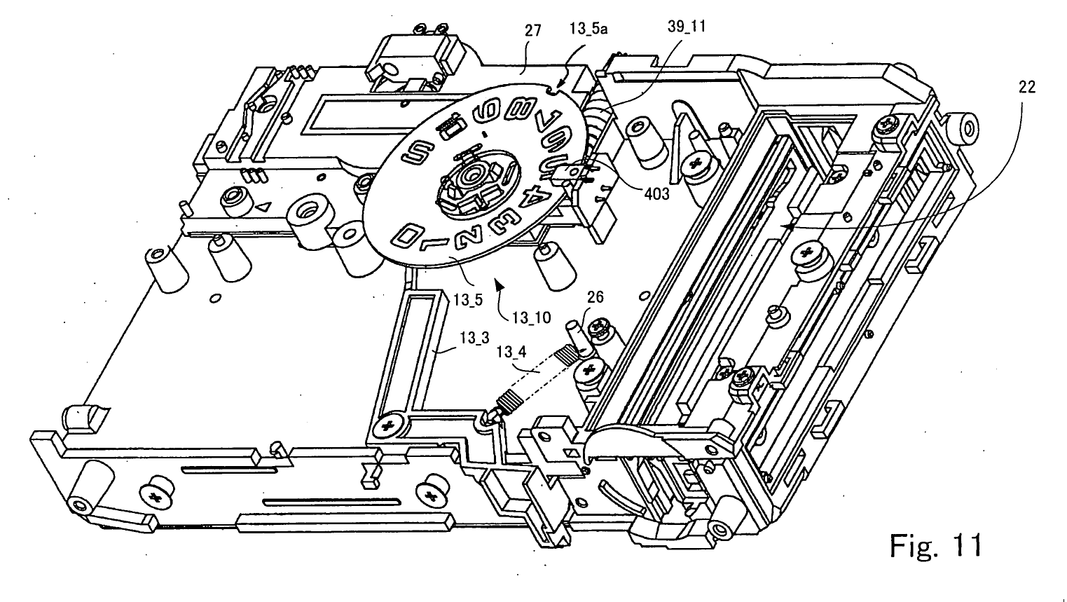

FIG. 10 is a perspective view of the printer according to this embodiment during a time when the enclosure is in a state of being removed from the printer at a time when the printer is viewed from above the top side. FIG. 11 is a perspective view of the printer shown in FIG. 10 during a time when an alphanumeric plate is in a state of being attached to the printer.

As shown in FIG. 10, this printer 1 is provided with a housing 51, a cover member 27 and a counter section 13_10. The pack compartment 22 is included in the housing 51. The cover member 27 is disposed on the top of the housing 51. The counter section 13_10 constitutes the counter 13. In addition, FIG. 10 shows the film door 20 that covers the pack compartment 22 openably and closably. A rib 20d having a slope section 20d1 is arranged in a standing condition in the film door 20.

The counter section 13_10 constituting the counter 13 includes a gear 13_1. The gear 13_1 is driven through a worm gear 39_11 that transmits rotational drive power of the dynamotor 406 (see FIG. 5). The alphanumeric plate 13_5 as shown in FIG. 11 is placed, and is held, on the top of the gear 13_1. This alphanumeric plate 13_5 has transparent alphanumeric characters “S” and “10” to “0.” In addition, an LED (not illustrated) is disposed underneath the alphanumeric plate 13_5. This LED back-lighting the alphanumeric plate 13_5 from the back of the plate makes it easy for the display of the counter 13 to be seen. Incidentally, the alphanumeric plate 13_5 shown in FIG. 11 is placed in a position which makes an alphanumeric character “8” seen through the window of the counter 13 shown in FIG. 1. The alphanumeric plate 13_5 includes a notch 13_5a between alphanumeric characters “7” and “8.”

An unused instant film pack includes the light-blocking plate. When the unused instant film pack is loaded into the printer, the notch 13_5a is placed in a monitoring position of the COUNTPI section 403. In addition, the alphanumeric character “S,” which indicates that the loaded instant film pack has been unused, is placed underneath the window. If power supply is turned on at this time, the COUNTPI section 403 detects the notch 13_5a. Thereby, the claw opens the light-blocking plate. Thus, an instant film sheet gets ready for use. Furthermore, the counter 13 is operated, and hence the alphanumeric plate 13_5 rotates counterclockwise. Then, the alphanumeric character “10,” which indicates that there are 10 instant film sheets left unused, is displayed while being back-lit. Thereafter, each time an image is recorded on an instant film sheet, an alphanumeric character which indicates the number of remaining instant film sheets is displayed by means of subtracting the number of used instant film sheets. When an image is recorded on a tenth instant film sheet, the alphanumeric character “0,” which indicates that there is no instant film sheet left unused, is displayed while being back-lit.

It should be noted that, in a case where the notch 13_5a of the counter 13 is detected when the light-blocking plate completes being operated to open, it is determined that the counter 13 does not operate. This lights the LED that indicates a communication error.

Moreover, the counter 13_10 includes a spring member 13_2, the counter lever 13_3, and a spring member 13_4. The spring member 13_2 energizes the gear 13_1 counterclockwise. The extremity of the counter lever 13_3 is engaged with teeth of the gear 13_1. An extremity of the spring member 13_4 is held by the counter lever 13_3, and the other extremity of the spring member 13_4 is held by a member 26. Thus, the spring member 13_4 energizes the counter lever 13_3. The counter lever 13_3 includes the rib 13_3a and a rib 13_3b. The rib 13_3a is pressed by means of loading an instant film pack. The rib 13_3b has a slope section 13_3b1 to be guided by the slope section 20d1 of the rib 20d which is arranged in a standing condition in the film door 20.

The counter 13 including the counter section 13_10 is a counter which performs counting operations in response to the sequence with which instant film sheets in an instant film pack loaded in the pack compartment 22 are transferred. This counter 13 is a ratchet counter which can be realized with a simple constitution, although the counter 13 will be described later in detail. If the printer includes the mechanical counter of this type, the printer does not have to include a memory which stores the number of instant sheet films 1001 in a case where the primary batteries 407 are removed.

In the case of this counter 13, the spring member 13_4 causes the counter lever 13_3 to rotate in a direction shown by an arrow A, when the following two conditions are satisfied at a time. One condition is that the film door 20 is opened. The other condition is that an instant film pack is subsequently unloaded from the pack compartment 22. This rotation disengages the extremity of the counter lever 13_3 from the teeth of the gear 13_1. This causes the spring member 13_2 to reset the gear 13_1 in the initial state. If the counter 13 is designed to operate in this manner, the counter 13 will not be reset even in a case where the film door 20 is once opened inadvertently and then is closed as it is when the inadvertent opening of the film door 20 is noticed. This solves the problem that makes the number of remaining films which can be actually used for photographing different from the number of remaining films which is displayed on the counter 13.

As well, the printer 1 according to this embodiment is designed to be set ready for counting operations to be performed in response to the subsequent sequence with which instant film sheets are transferred, when one of the following two conditions is satisfied. One condition is that the film door 20 is closed. The other condition is that an instant film pack is loaded into the pack compartment 22. For this reason, in a case where the film door 20 is closed, for example, while no instant film pack is in a state of being loaded in the pack compartment 22, the printer 1 is set for the counting operations to be performed in response to the subsequent sequence with which instant film sheets are transferred. Specifically, the slope section 20d1 of the rib 20d which is arranged in a standing condition in the film door 20 is guided by the slope section 13_3b1 of the rib 13_3b which is provided to the counter lever 13_3. This engages the extremity of the counter lever 13_3 with teeth of the gear 13_1. While the printer 1 is in such a condition, operations of the printer 1 can be checked by means of performing a series of sequence operations through infrared communication and the like.

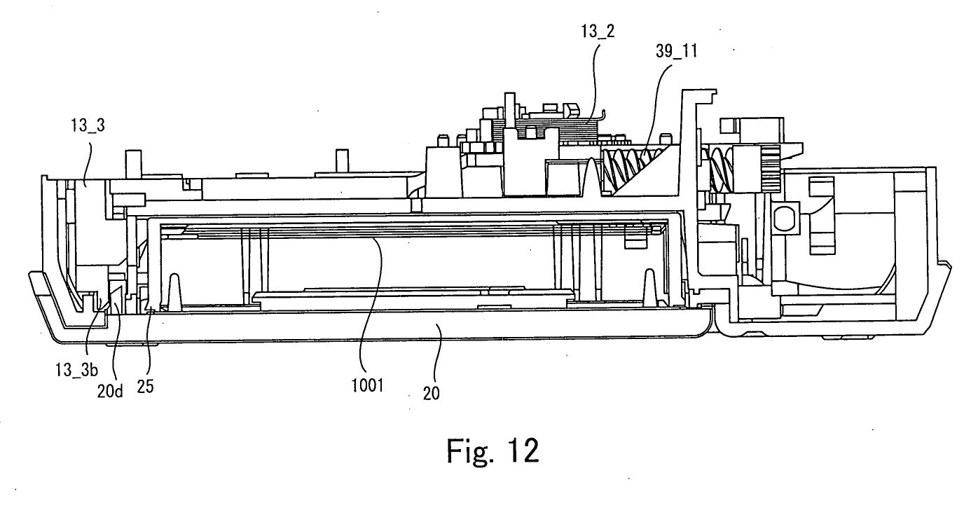

FIG. 12 is a cross-sectional view of the printer shown in FIG. 10 during a time when the film door is in a state of being closed with an instant film pack loaded in the printer.

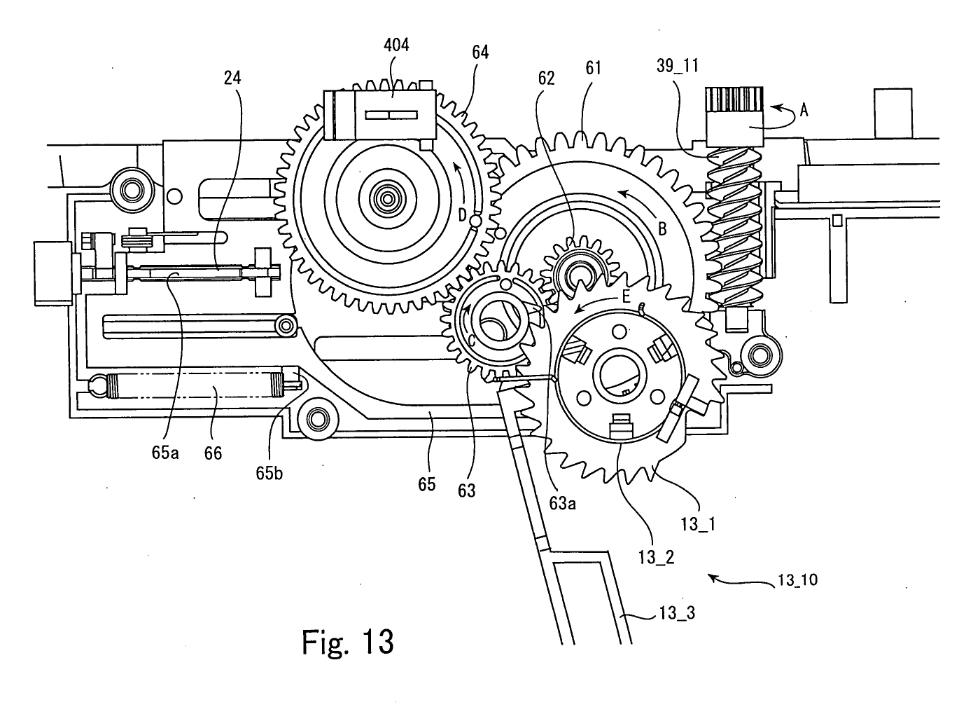

FIG. 12 shows: the film door 20; the rib 20d provided to the film door 20; the counter lever 13_3; and the rib 13_3b provided to the counter lever 13_3. In addition, FIG. 12 shows an instant film pack 25 in which instant film sheets 1001 are contained in stack. Here is shown the film door 20 that is in a state of being closed with the instant film pack 25 loaded in the printer. While the film door 20 is in such a condition, the rib 20d of the film door 20 presses the rib 13_3b of the counter lever 13_3. For this reason, the extremity of the counter lever 13_3 is engaged with teeth of the gear 13_1, as shown in FIG. 13, which will be described below.

FIG. 13 is a plan view of the printer shown in FIG. 10 during a time when the cover member is in a state of being removed from the printer.

FIG. 13 shows the counter section 13_10, the worm gear 39_11, a three-turn cam 61 (a cam which makes three turns as described later), a gear 62, a gear 63 and a one-turn cam 64 (a cam which makes one turn as described later). The worm gear 39_11 rotates in a direction shown by an arrow A. The three-turn cam 61 receives rotational drive power from the worm gear 39_11, and thereby makes 3 turns in a direction shown by an arrow B. The gear 62 rotates in response to the rotation of the three-turn cam 61. The gear 63 is engaged with the gear 62, and thereby rotates in a direction shown by an arrow C. The one-turn cam 64 receives rotational drive power from the gear 63, and thereby makes one turn in a direction shown by an arrow D. In this regard, the one-turn cam 64 is a cam that completes a series of sequence operations which transfer an instant film sheet by means of making one turn. The one-turn cam 64 makes one turn each time the three-turn cam 61 makes three turns. In addition, the cam-operated switch 404 with which to monitor the initial position of the series of sequence operations is placed, and is held, on the top of the one-turn cam 64.

Furthermore, FIG. 13 shows a claw plate 65 and a spring member 66 that energizes the claw plate 65. The claw plate 65 is provided with a straight guide groove 65a which guides the claw 24 and a holding member 65b which holds the spring member 66.

While the film door 20 is in the state of being closed with the instant film pack 25 loaded in the printer as shown in FIG. 12, which has been described, the extremity of the counter lever 13_3 is engaged with teeth of the gear 13_1. In this respect, when the worm gear 39_11 rotates in the direction shown by the arrow A, the three-turn cam 61 rotates in the direction shown by the arrow B. Thereby, the claw plate 65 begins to be raised up towards the worm gear 39_11. Once the claw plate 65 begins to be raised up, the straight guide groove 65a provided to the claw plate 65 guides, and raises, the claw 24. Thereby, an instant film sheet 1001 begins to be lifted up. The gear 62 rotates in response to the rotation of the three-turn cam 61, and the rotational drive power of the gear 62 is transmitted to the gear 63. Thereby, the gear 63 rotates in the direction shown by the arrow C. This gear 63 includes a claw 63a. This claw 63a functions so as to press teeth of the gear 13_1 of the counter 13 downwards. Then, the gear 13_1 rotates in a direction shown by an arrow E. Thereby, the extremity of the counter lever 13_3, which extremity is engaged with teeth of the gear 13_1, climbs over the upper tooth of the teeth, and thus is engaged with the upper teeth which come next. Such an operation is repeated twice in a series of sequence operations. In other words, the gear 13_1 of the counter 13 rotates by two teeth in the direction shown by the arrow E. Thereby, the alphanumeric plate 13_5 rotates in a direction which subtracts one from a currently-displayed number. Each time an instant film sheet 1001 is discharged, one is subtracted from the current number displayed on the counter 13 in this manner.

In this respect, the counter 13 is arranged on a plane which is situated on the same side as a plane opposite to the exposed surface of each of the instant film sheets in an instant film pack 25 loaded in the pack compartment 22 is situated. An area of a surface of the printer 1, which surface is opposite to the exposed surface of each of the instant film sheets 1001, is larger. It results in easing the restriction on the area in which the counter is disposed, thus realizing a larger counter 13. As a consequence, each of the alphanumeric characters to indicate the number of remaining instant film sheets 1001 is larger. In combination with the back-lighting of the alphanumeric plate 13_5, the larger alphanumeric characters realize a display which is easy to see.

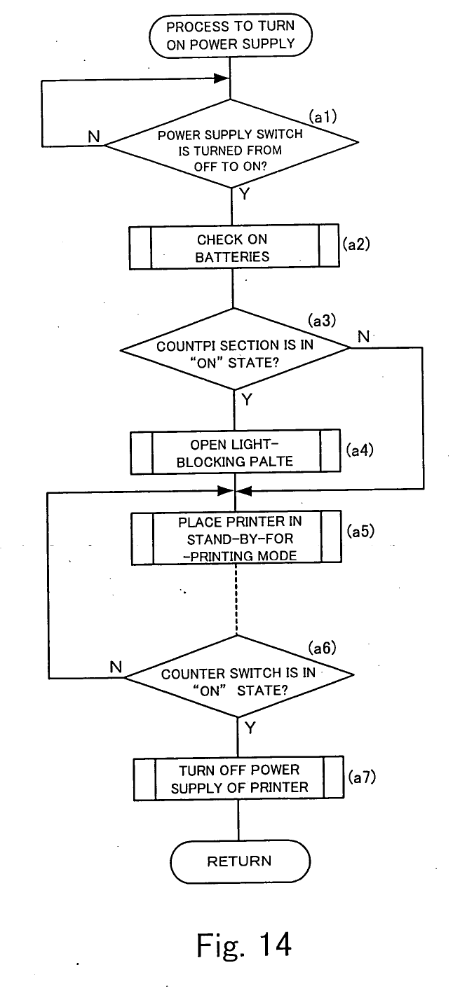

FIG. 14 is a flowchart showing a sequence with which the power supply switch of this printer is turned on and off.

When the power supply SW 11 (see FIG. 1) is turned from off to on by means of pressing the power supply SW 11 (in step a1), power is supplied from the primary batteries 407. First of all, the batteries are checked to determine whether or not sufficient power remains in the primary batteries 407 (in step a2). Subsequently, the COUNTPI section 403 detects whether or not the counter 13 is in an initial state (an “on” state) where the alphanumeric character “S” looks through the window of the counter 13 (in step a3). If the COUNTPI section 403 detects that the counter 13 is in the initial state (the “on” state), the claw is operated in order to open the light-blocking plate of an instant film pack in the pack compartment (in step a4). Thereafter, the printer is placed in a stand-by-for-printing mode which gets the printer ready for the printing operations, that is, for recording an image by means of receiving the image data from a cellular phone (in step a5). If the COUNTPI section 403 detects in step a3 that the counter 13 has already not been in the initial state (the counter 13 has already been in an “off” state), the flow proceeds to step a5 by skipping over step a4. This is because the light-blocking plate of the instant film pack has already been opened.

After step a5, printing operations are actually performed, for example, with some instant film sheets. Each time one sequence for printing operations is completed, the COUNTPI section 403 determines whether or not the counter 13 is in the initial state (the “on” state) (in step a6). The counter 13 is returned to the initial state when the instant film pack is removed from the pack compartment. If it is detected in step a6 that the counter is in this initial state (the “on” state), the power supply to the printer is shut off (in step a7). In this respect, after the light-blocking plate is opened, even in a case where the power supply SW is turned on and off several times, the operations are performed duly.

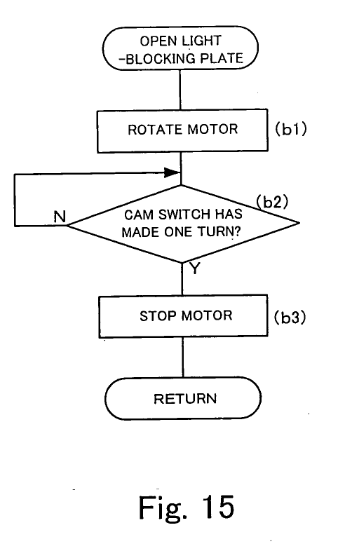

FIG. 15 is a flowchart showing a sequence with which the light-blocking plate is opened, and the opening of the light-blocking plate is shown as a step in FIG. 14.

When the light-blocking plate is intended to be opened, performed is the same sequence with which instant film sheets in an instant film pack is transferred, except that no exposure is performed.

In other words, at this point, the dynamotor 406 (see FIG. 5) is caused to rotate (in step b1), and accordingly the claw opens the light-blocking plate. When the cam-operated switch 414 (see FIG. 13) detects that the one-turn cam 64 has made one turn (Yes at step b2), the dynamotor 406 is stopped from rotating (step b3). At this time, the transfer rollers 31 and 32 as well as the spread rollers 33 and 34 rotate ineffectively. This is because the same sequence with which instant film sheets are transferred is performed.

In the case of this embodiment, the ratchet counter is included as the counter 13, and the conditions of the counter are designed to be maintained even if no power is supplied. In addition, the counter 13 is designed to return to the initial state even while the power supply is off, when an instant film pack in the pack compartment is replaced with another one. For these reasons, there is no need to keep the power supply tuned on. If the conditions of the counter are detected only when the power supply is turned on and while the power supply is on, the sequence operations can be performed duly. This enables power to be saved.

In the case of this embodiment, the image-recording apparatus according to the present invention has been described, giving the example of the printer in which recording media in a media pack in the pack compartment are sent out one by one, and images are recorded respectively on the recording media by means of writing the images respectively on the recording media while transferring the recording media in the predetermined transfer direction. It should be noted, however, that the image-recording apparatus according to the present invention is not limited to this. The image-recording apparatus according to the present invention may be a camera which uses recording media in a media pack which are photosensitized materials, and which takes photos respectively on the recording media in the media pack loaded in the pack compartment and thereafter sends out after-photographed recording media.

What is claimed is:

1. An image-recording apparatus, which includes a pack compartment which accommodates a media pack containing a plurality of stacked recording media to record images thereon respectively, and which sequentially records images respectively on the plurality of recording media accommodated in the pack compartment, one by one, and sending out the recording media on which the images have been thus recorded, comprising:
a film door which covers the pack compartment openably and closably; and
a counter which performs counting operations in response to a sequence with which the recording media in the media pack loaded in the pack compartment are transferred,
wherein the counter is reset when the film door is opened and concurrently the media pack is unloaded from the pack compartment, and
wherein the counter is set ready to perform counting operations in the subsequent sequence with which the recording media are transferred, any one of when the film door is closed and when the media pack is loaded into the pack compartment.

2. The image-recording apparatus according to claim 1, wherein the counter is disposed on a plane opposite to surfaces respectively of the recording media in the media pack loaded in the pack compartment.

3. The image-recording apparatus according to claim 1, wherein the image-recording apparatus is a printer which sends out the recording media in the media pack loaded in the pack compartment one by one, and writes on the recording media while transferring the recording media in a predetermined transfer direction, thus recording the images respectively on the recording media.

4. The image-recording apparatus according to claim 1,
wherein the recording media in the media pack are photosensitized materials, and
wherein the image-recording apparatus is a camera which takes photos respectively on the recording media in the media pack loaded in the pack compartment, and which sends out after-photographed recording media.

5. An image-recording apparatus, which includes a pack compartment into which accommodates a media pack containing a plurality of stacked recording media to record images thereon respectively, and which records images respectively on the recording media by use of the recording media contained in the media pack accommodated in the pack compartment and sends the recording media out of the apparatus, comprising:
a mechanical counter which, by means of change in any one of its position and posture, displays that the media pack loaded in the pack compartment is in a state of being unused, and concurrently displays any one of how many sheets of the recording media have been taken out of the media pack after the media pack begins to be used and how many sheets of the recording media have remained in the media pack, which maintains the display even when power supply is shut off, and which is returned to a display indicating the unused state when the media pack is taken out of the pack compartment;
a sensor which detects whether or not the mechanical counter displays the unused state; and
a control section which responds to the detection by the sensor that the mechanical counter displays the unused state when power supply is turned on, thus turning the media pack in the pack compartment and the mechanical counter to a condition where the media pack and the mechanical counter get ready to be used.

6. The image-recording apparatus according to claim 5, wherein the control section responds to the detection by the sensor that the mechanical counter displays the unused state while the power supply is in a state of being turned on after the power supply is turned on, thus shutting off the power supply.

7. The image-recording apparatus according to claim 5, wherein the mechanical counter is a ratchet counter.

8. The image-recording apparatus according to claim 5, wherein the mechanical counter is disposed on a plane opposite to surfaces respectively of the recording media in the media pack loaded in the pack compartment.

9. The image-recording apparatus according to claim 5, where the image-recording apparatus sends out the recording media in the media pack loaded in the pack compartment one by one, and writes the images respectively on the recording media while transferring the recording media in a predetermined transfer direction, thus recording the images respectively on the recording media.

10. The image-recording apparatus according to claim 9,
wherein the recording media in the media pack are photosensitized materials, and
wherein the image-recording apparatus writes latent images respectively on the recording media by means of exposing the recording media, and develops the recording media while the image-recording apparatus is in the process of transferring the recording media, thereby recording the images respectively on the recording media.
